(19) United States
(12) Patent Application Publication
(10) Pub. No.: US 2018/0109471 A1
(43) Pub. Date: Apr. 19, 2018

(54) GENERALIZED PACKET PROCESSING OFFLOAD IN A DATACENTER

(71) Applicants: Hyunseok Chang, Holmdel, NJ (US); Tirunell V. Lakshman, Morganville, NJ (US); Sarit Mukherjee, Morganville, NJ (US); Limin Wang, Plainsboro, NJ (US)

(72) Inventors: Hyunseok Chang, Holmdel, NJ (US); Tirunell V. Lakshman, Morganville, NJ (US); Sarit Mukherjee, Morganville, NJ (US); Limin Wang, Plainsboro, NJ (US)

(73) Assignee: Alcatel-Lucent USA Inc., Murray Hill, NJ (US)

(21) Appl. No.: 15/292,509

(22) Filed: Oct. 13, 2016

(51) Int. Cl. H04L 12/937; H04L 12/931

(52) U.S. Cl. CPC H04L 49/253; H04L 49/70

(57) ABSTRACT

The present disclosure generally discloses packet processing offload support capabilities for supporting packet processing offload. The packet processing offload support capabilities may be configured to support general and flexible packet processing offload at an end host by leveraging a processing device (e.g., a smart network interface card (sNIC) or other suitable processing device) added to the end host to support offloading of various packet processing functions from the hypervisor of the end host to the processing device added to the end host. The packet processing offload support capabilities may be configured to support packet processing offload by including, within the end host, a virtualization switch and a packet processing offload agent which may be configured to cooperate to transparently offload at least a portion of the packet processing functions of the end host from the hypervisor of the end host to an sNIC of the end host while keeping the existing management plane and control plane interfaces of the datacenter unmodified.

### TECHNICAL FIELD

The present disclosure relates generally to packet processing and, more particularly but not exclusively, to packet processing offload in datacenters.

### BACKGROUND

In many datacenters, hypervisors of end hosts are typically used to run tenant applications. However, in at least some datacenters, hypervisors of end hosts also may be used to provide various types of packet processing functions. Increasingly, smart Network Interface Cards (sNICs) are being used in datacenters to partially offload packet processing functions from the hypervisors of the end hosts, thereby making the hypervisors of the end hosts available for running additional tenant applications. The use of an sNIC for offloading of packet processing functions typically requires use of multiple instances of software switches (e.g., one on the hypervisor and one on the sNIC) to interconnect the tenant applications and the offload packet processing functions running on the hypervisor and the SNIC. However, having multiple instances of software switches, deployed across the hypervisor and the sNIC of the end host, may make data plane and control operations more difficult.

### SUMMARY

The present disclosure generally discloses packet processing offload in datacenters.

In at least some embodiments, an apparatus is provided. The apparatus includes processor and a memory communicatively connected to the processor. The processor is configured to receive, at a virtualization switch of an end host configured to support a virtual data plane on the end host, port mapping information. The port mapping information includes a set of port mappings including a mapping of a virtual port of the virtual data plane of the virtualization switch to a physical port of an element switch of an element of the end host. The element switch of the element of the end host is a hypervisor switch of a hypervisor of the end host or a processing offload switch of a processing offload device of the end host. The processor is configured to translate, at the virtualization switch based on the port mapping information, a virtual flow rule specified based on the virtual port into an actual flow rule specified based on the physical port. The apparatus is configured to send the actual flow rule from the virtualization switch toward the element switch of the element of the end host.

In at least some embodiments, a non-transitory computer-readable storage medium stores instructions which, when executed by a computer, cause the computer to perform a method. The method includes receiving, at a virtualization switch of an end host configured to support a virtual data plane on the end host, port mapping information. The port mapping information includes a set of port mappings including a mapping of a virtual port of the virtual data plane of the virtualization switch to a physical port of an element switch of an element of the end host. The element switch of the element of the end host is a hypervisor switch of a hypervisor of the end host or a processing offload switch of a processing offload device of the end host. The method includes translating, at the virtualization switch based on the port mapping information, a virtual flow rule specified based on the virtual port into an actual flow rule specified based on the physical port. The method includes sending the actual flow rule from the virtualization switch toward the element switch of the element of the end host.

In at least some embodiments, a method is provided. The method includes receiving, at a virtualization switch of an end host configured to support a virtual data plane on the end host, port mapping information. The port mapping information includes a set of port mappings including a mapping of a virtual port of the virtual data plane of the virtualization switch to a physical port of an element switch of an element of the end host. The element switch of the element of the end host is a hypervisor switch of a hypervisor of the end host or a processing offload switch of a processing offload device of the end host. The method includes translating, at the virtualization switch based on the port mapping information, a virtual flow rule specified based on the virtual port into an actual flow rule specified based on the physical port. The method includes sending the actual flow rule from the virtualization switch toward the element switch of the element of the end host.

In at least some embodiments, an apparatus is provided. The apparatus includes processor and a memory communicatively connected to the processor. The processor is configured to instantiate a virtual resource on an element of an end host. The element of the end host is a hypervisor of the end host or a processing offload device of the end host. The processor is configured to connect the virtual resource to a physical port of an element switch of the element of the end host. The processor is configured to create a virtual port for the virtual resource on a virtual data plane of the end host. The processor is configured to create a port mapping between the virtual port for the virtual resource and the physical port of the element switch of the element of the end host.

In at least some embodiments, a non-transitory computer-readable storage medium stores instructions which, when executed by a computer, cause the computer to perform a method. The method includes instantiating a virtual resource on an element of an end host. The element of the end host is a hypervisor of the end host or a processing offload device of the end host. The method includes connecting the virtual resource to a physical port of an element switch of the element of the end host. The method includes creating a virtual port for the virtual resource on a virtual data plane of the end host. The method includes creating a port mapping between the virtual port for the virtual resource and the physical port of the element switch of the element of the end host.

In at least some embodiments, a method is provided. The method includes instantiating a virtual resource on an element of an end host. The element of the end host is a hypervisor of the end host or a processing offload device of the end host. The method includes connecting the virtual resource to a physical port of an element switch of the element of the end host. The method includes creating a virtual port for the virtual resource on a virtual data plane of the end host. The method includes creating a port mapping between the virtual port for the virtual resource and the physical port of the element switch of the element of the end host.

In at least some embodiments, an apparatus is provided. The apparatus includes processor and a memory communicatively connected to the processor. The processor is configured to receive, by an agent of an end host from a controller, a request for instantiation of a virtual resource on the end host. The processor is configured to instantiate, by the agent, the virtual resource on an element of an end host. The element of the end host is a hypervisor of the end host or a processing offload device of the end host. The processor is configured to connect, by the agent, the virtual resource to a physical port of an element switch of the element of the end host. The processor is configured to create, by the agent on a virtual data plane of a virtualization switch of the end host, a virtual port that is associated with the physical port of the element switch of the element of the end host. The processor is configured to send, from the agent toward the controller, an indication of the virtual port without providing an indication of the physical port. The processor is configured to create, by the agent, a port mapping between the virtual port for the virtual resource and the physical port of the element switch of the element of the end host. The processor is configured to provide, from the agent to the virtualization switch, the port mapping between the virtual port for the virtual resource and the physical port of the element switch of the element of the end host; receive, by the virtualization switch from the controller, a virtual flow rule specified based on the virtual port. The processor is configured to translate, by the virtualization switch based on port mapping, the virtual flow rule into an actual flow rule specified based on the physical port. The processor is configured to send, by the virtualization switch toward the element switch of the element of the end host, the actual flow rule.

### BRIEF DESCRIPTION OF THE DRAWINGS

The teachings herein can be readily understood by considering the following detailed description in conjunction with the accompanying drawings, in which:

FIG. 1 depicts an exemplary datacenter system for illustrating packet processing offload support capabilities;

FIG. 2 depicts an exemplary end host including a physical data plane and including a virtual data plane that is configured for use in transparently supporting packet processing offload in the physical data plane of the end host;

FIGS. 3A-3B depict exemplary NF instance deployment and migration scenarios within the context of the exemplary end host of FIG. 2 for illustrating use of the virtual data plane of the end host to transparently supporting packet processing offload in the physical data plane of the end host;

FIG. 4 depicts an exemplary end host including a network function agent and a virtualization switch which are configured to cooperate to support transparent packet processing offload;

FIG. 5 depicts an exemplary embodiment of a method for use by an agent of an end host to hide details of the physical data plane of the end host;

FIG. 6 depicts an exemplary embodiment of a method for use by a virtualization switch of an end host to hide details of the physical data plane of the end host;

FIG. 7A-7C depict exemplary offload embodiments which may be realized based on embodiments of packet processing offload support capabilities; and

FIG. 8 depicts a high-level block diagram of a computer suitable for use in performing various operations described herein.

To facilitate understanding, identical reference numerals have been used, where possible, to designate identical elements that are common to the figures.

### DETAILED DESCRIPTION

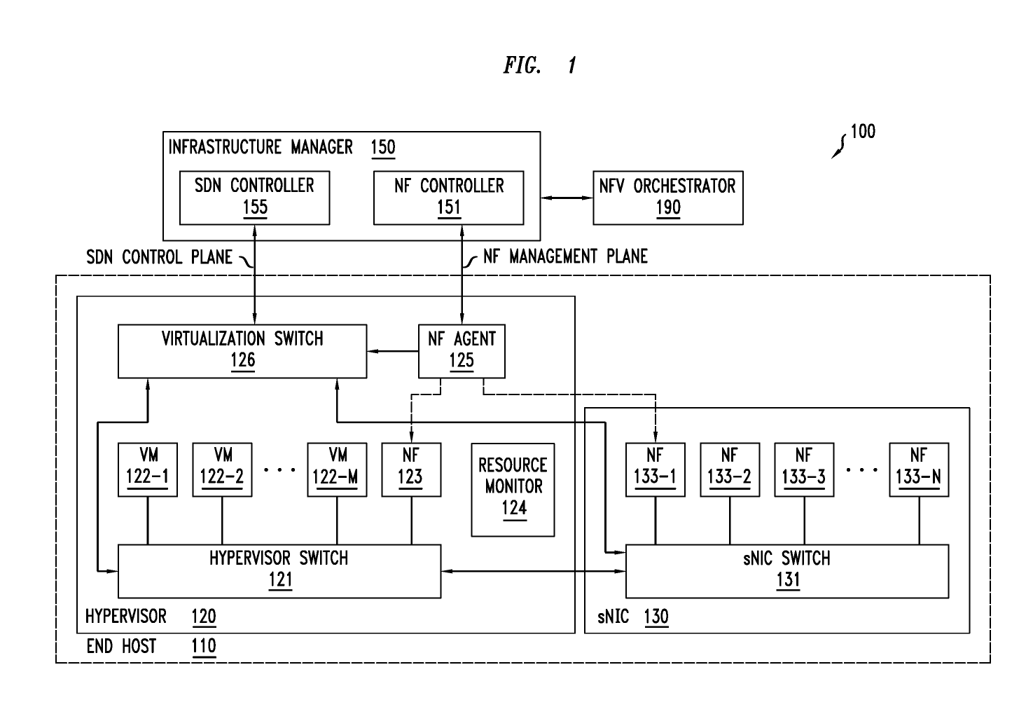

The present disclosure generally discloses packet processing offload support capabilities for supporting packet processing offload. The packet processing offload support capabilities may be configured to support packet processing offload within various types of environments (e.g., in datacenters, as primarily presented herein, as well as within various other suitable types of environments). The packet processing offload support capabilities may be configured to support general and flexible packet processing offload at an end host by leveraging a processing device (e.g., a smart network interface card (sNIC) or other suitable processing devices) added to the end host to support offloading of various packet processing functions from the hypervisor of the end host to the processing device added to the end host. The packet processing offload support capabilities may be configured to support packet processing offload by including, within the end host, a virtualization switch and a packet processing offload agent (e.g., a network function agent (NFA), or other suitable packet processing offload agent, configured to provide network function offload) which may be configured to cooperate to transparently offload at least a portion of the packet processing functions of the end host from the hypervisor of the end host to an sNIC of the end host while keeping northbound management plane and control plane interfaces unmodified. The packet processing offload support capabilities may be configured to support packet processing offload by configuring the end host to support a virtual packet processing management plane while hiding dynamic packet processing offload from the hypervisor to the sNIC from northbound management interfaces and systems. The packet processing offload support capabilities may be configured to support packet processing offload by configuring the end host to expose a single virtual data plane for multiple switches (e.g., hypervisor switch(es), sNIC switch(es), or the like) while hiding dynamic packet processing offload from the hypervisor to the sNIC(s) from northbound control interfaces and systems. These and various other embodiments and advantages of the packet processing offload support capabilities may be further understood by way of reference to a general description of typical datacenter environments as well as by way of reference to the exemplary datacenter system of FIG. 1.

FIG. 1 depicts an exemplary datacenter system for illustrating packet processing offload support capabilities.

Referring to FIG. 1, datacenter system 100 includes an end host (EH) 110, an infrastructure manager (IM) 150, and a network function virtualization (NFV) orchestrator (NFVO) 190. The EH 110 includes a hypervisor 120 and an sNIC 130. The hypervisor 120 includes a hypervisor switch (HS) 121, a set of virtual machines (VMs) 122-1-122-N (collectively, VMs 122), a network function (NF) 123, a resource monitor (RM) 124, an NF agent (NFA) 125, and a virtualization switch (VS) 126. The sNIC 130 includes an sNIC switch (SS) 131 and a set of network functions (NFs) 133-1-133-M (collectively, NFs 133). The hypervisor 120 and the sNIC 130 may be interconnected via a communication link (e.g., a bus such as a Peripheral Component Interconnect (PCI) bus or other suitable type of bus or link), which also may be referred to herein as an inter-switch communication link as it provides a communication for communications between HS 121 of hypervisor 120 and SS 131 of sNIC 130. The IM 150 includes an NF controller (NFC) 151 and a Software Defined Networking (SDN) controller (SDNC) 155.

The EH 110 is a server that is configured to provide an edge-based datacenter that is typical for SDN-based datacenters. In general, in an edge-based datacenter, the tenant resources (e.g., which may include VMs, virtual containers (VCs), or other types of virtual resources, but which are primarily described herein as being VMs) and virtual instances of NFs are hosted at end-host servers, which also run hypervisor switches (e.g., Open vSwitches (OVSs)) configured to handle communications of the end-host servers (e.g., communications by and between various combinations of end elements, such as VMs (or containers or the like), NFs, remote entities, or the like, as well as various combinations thereof). In general, computing resources (e.g., central processing unit (CPU) cores, memory, input/output (I/O), or the like) of the end-host servers are used for several tasks, including execution of the tenant VMs, execution of the NFs providing specialized packet processing for traffic of the VMs, packet switch and routing on the hypervisor switch of the end-host server, and so forth. It will be appreciated that execution of the tenant VMs is typically the cost that is visible to the datacenter tenants, while the other functions are considered to be infrastructure support used to support the execution of the tenant VMs. It also will be appreciated that, while server end-hosts typically rely on cost-effective use of host hardware by infrastructure software, there are various technological trends that are contributing to associated infrastructure cost increases (e.g., increasing speeds of datacenter interconnects lead to more computational load in various NFs, increased load on hypervisor software switches due to increasing numbers of lightweight containers and associated virtual ports, new types of packet processing functions requiring more CPU cycles for the same amount of traffic at the end-host servers, or the like). It is noted that such trends are causing increasingly larger fractions of the processing resources of end-host servers to be dedicated to packet processing functions in the NFs and hypervisor switches at the end-host servers, thereby leaving decreasing fractions of the processing resources of the end-host servers available for running tenant applications.

The hypervisor 120 is configured to support virtualization of physical resources of EH 110 to provide virtual resources of the EH 110. The virtual resources of the EH 110 may support tenant resources (primarily presented as being tenant VMs (illustratively, VMs 122), but which also or alternatively may include other types of tenant resources such as tenant VCs or the like), virtualized NFs (illustratively, NF 123), or the like. It will be appreciated that the virtualized NFs (again, NFs 123) may be provided using VMs, VCs, or any other suitable type(s) of virtualized resources of the EH 110. The HS 121 is configured to support communications of the VMs and NFs (again, VMs 122 and NF 123) of the hypervisor 120, including intra-host communications within EH 110 (including within hypervisor 120 and between hypervisor 120 and sNIC 130) as well as communications outside of EH 110. The HS 121 is communicatively connected to the VMs and NFs (again, VMs 122 and NF 123) of the hypervisor 120, the SS 131 (e.g., over PCI using virtual port abstraction (e.g., netdev for OVS)), and the VS 126. The RM 124 is configured to monitor resource usage on hypervisor 120 and sNIC 130. The VS 126 and NFA 125 cooperate to support transparent data plane offloading at EH 110. The VS 126 is communicatively connected to the HS 121 and the SS 131 via data plane connectivity. The VS 126 also is communicatively connected to the SDNC 155 of IM 150 via control plane connectivity. The VS 126 is configured to hide the sNIC 130 from the SDNC 155 of IM 150. The NFA 125 is communicatively connected to the NFC 151 of IM 150 using management plane connectivity. The NFA 125 is configured to control NFs on EH 110 (including NF 123 hosted on hypervisor 120, as well as NFs 133 offloaded to and hosted on sNIC 130), under the control of NFC 151. The NFA 125 is configured to make the NFC 151 of IM 150 agnostic as to where NF instances deployed on EH 110 (namely, on hypervisor 120 or sNIC 130). The operation of VS 126 and NFA 125 in supporting transparent data plane offloading at EH 110 is discussed further below.

The sNIC 130 is a device configured to offload packet processing functions from the hypervisor 120, thereby offsetting increasing infrastructure cost at the edge. In general, the sNIC 130 may utilize much more energy-efficient processors than utilized for the hypervisor 120 (e.g., compared to x86 host processors or other similar types of processors which may be utilized by hypervisors), thereby achieving higher energy efficiency in packet processing. It will be appreciated that, in general, sNICs may be broadly classified into two categories: (1) hardware acceleration sNICs, where a hardware acceleration sNIC is typically equipped with specialty hardware that can offload pre-defined packet processing functions (e.g., Open vSwitch fastpath, packet/flow filtering, or the like) and (2) general-purpose sNICs, where a general-purpose sNIC is typically equipped with a fully-programmable, system-on-chip multi-core processor on which a full-fledged operating system can execute any arbitrary packet processing functions. The sNIC 130, as discussed further below, is implemented as a general-purpose sNICs configured to execute various types of packet processing functions including SS 131. The sNIC 130 supports NF instances that have been opportunistically offloaded from the hypervisor 120 (illustratively, NFs 133). The SS 131 is configured to support communications of the NFs 133 of the sNIC 130, including intra-sNIC communications within the sNIC 130 (e.g., between NFs 133, such as where NF chaining is provided) as well as communications between the sNIC 130 and the hypervisor 120 (via the HS 121). The SS 131 is communicatively connected to the NFs 133 of the sNIC 130, the HS 121 (e.g., over PCI using virtual port abstraction (e.g., netdev for OVS)), and the VS 126. The SS 131 may connect the offloaded NFs between the physical interfaces of the sNIC 130 and the HS 121 of the hypervisor 120. The SS 131 may be hardware-based or software-based, which may depend on the implementation of sNIC 130. The SS 131 is configured to support transparent data plane offloading at EH 110. The operation of SS 131 in supporting transparent data plane offloading at EH 110 is discussed further below.

The IM 150 is configured to provide various management and control operations for EH 110. The NFC 151 of IM 150 is communicatively connected to NFA 125 of hypervisor 120 of EH 110, and is configured to provide NF management plane operations for EH 110. The NF management plane operations which may be provided by NFC 151 of IM 150 for EH 150 (e.g., requesting instantiation of NF instances and the like) will be understood by one skilled in the art. The NFA 125 of EH 110, as discussed above, is configured to keep NF offload from the hypervisor 120 to the sNIC 130 hidden from the NFC 151 of IM 150. The SDNC 155 of IM 150 is communicatively connected to VS 126 of hypervisor 120 of EH 110, and is configured to provide SDN control plane operations for VS 126 of EH 110. The SDN control plane operations which may be provided by SDNC 155 of IM 150 for VS 126 of EH 150 (e.g., determining flow rules, installing flow rules on HS 121, and the like) will be understood by one skilled in the art. The VS 126 of EH 110, as discussed above, is configured to keep NF offload from the hypervisor 120 to the sNIC 130 hidden from the SDNC 155 of IM 150. The IM 150 may be configured to support various other control or management operations.

The NFVO 190 is configured to control NF offload within the datacenter system 100. The NFVO 190 is configured to control the operation of IM 150 in providing various management and control operations for EH 110 for controlling NF offload within the datacenter system 100.

It will be appreciated that, while use of separate switches (illustratively, HS 121 and SS 131) may achieve flexible data plane offload from hypervisor 120 to sNIC 130, such flexibility is also expected to introduce additional complexity in the centralized management and control planes of the data center if all of the offload intelligence were to be placed into the centralized management and control systems (illustratively, NFC 151 and SDNC 155 of IM 150). For example, for the switching function to be split between the two switches on the end host, the centralized management system would need to be able to make NF instance location decisions (e.g., deciding which of the two switches on the end host to which NF instances are to be connected, when to migrate NF instances between two switches, or the like) and to provision the switches of the end host accordingly, even though the end host is expected to be better suited than the centralized management system to make such NF instance location decisions (e.g., based on resource utilization information of the hypervisor, resource utilization information of the sNIC, inter-switch communication link bandwidth utilization information of the EH 110 (e.g., PCI bus bandwidth utilization where the communication link between the HS 121 of hypervisor 120 and the SS 131 of sNIC 130 is a PCI bus), availability of extra hardware acceleration capabilities in the sNIC, or the like, as well as various combinations thereof). Similarly, for example, for the switching function to be split between the two switches on the end host, the centralized control system (e.g., SDNC 155) would need to be able to control both switches on the end host. Accordingly, in at least some embodiments as discussed above, the EH 110 may be configured to provide virtualized management and control plane operations (e.g., the NFA 125 of the EH 110 may be configured to provide virtualized management plane operations to abstract from NFC 151 the locations at which the NF instances are placed and the VS 126 of EH 110 may be configured to provide virtualized control plane operations to hide the multiple switches (namely, the HS 121 and the SS 131) from the SDNC 155 when controlling communications of EH 110).

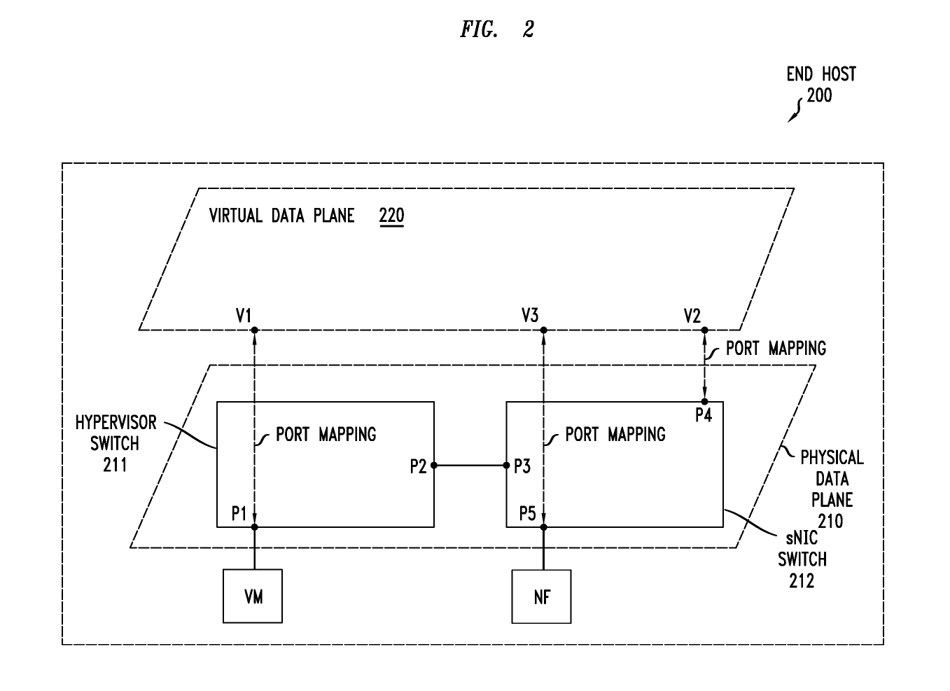

The NFA 125 and VS 126 may be configured to cooperate to provide, within the EH 110, a virtualized management plane and control plane which may be used to keep the sNIC data plane offload hidden from external controllers (illustratively, IM 150). The virtualized management plane abstracts the locations at which NF instances are deployed (namely, at the hypervisor 120 or sNIC 130). The virtual control plane intelligently maps the end host switches (namely, HS 121 and SS 131) into a single virtual data plane which is exposed to external controllers (illustratively, IM 150) for management and which is configured to support various abstraction/hiding operations as discussed further below. It is noted that an exemplary virtual data plane is depicted and described with respect to FIG. 2. When an external controller adds a new NF instance on the EH 110 or installs a flow rule into the virtual data plane of the EH 110, the NF instance is deployed on either of the end host switches via the virtual management plane (such that sNIC offloading is hidden from the external controller) and the flow rule is mapped appropriately to the constituent end host switch(es) via the control plane mapping (again, such that sNIC offloading is hidden from the external controller). The EH 110 has the intelligence to decide the location at which the NF instance is deployed. The EH 110 also dynamically migrates NF instances (along with their internal states) between the hypervisor 120 and the sNIC 130 and triggers any necessary remapping for associated switch ports and flow rules in the virtual control plane, such that the migration is hidden from any external controllers. In this manner, virtualized management and control planes allow any centralized controllers to remain oblivious to the sNIC 130 and to dynamic offload between the hypervisor 120 and sNIC 130.

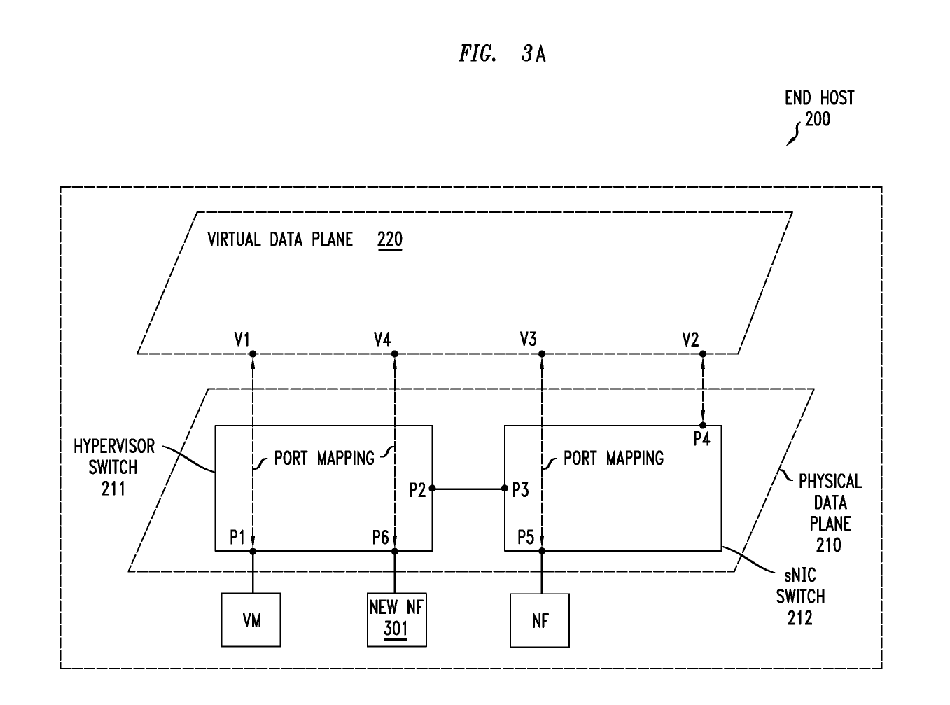

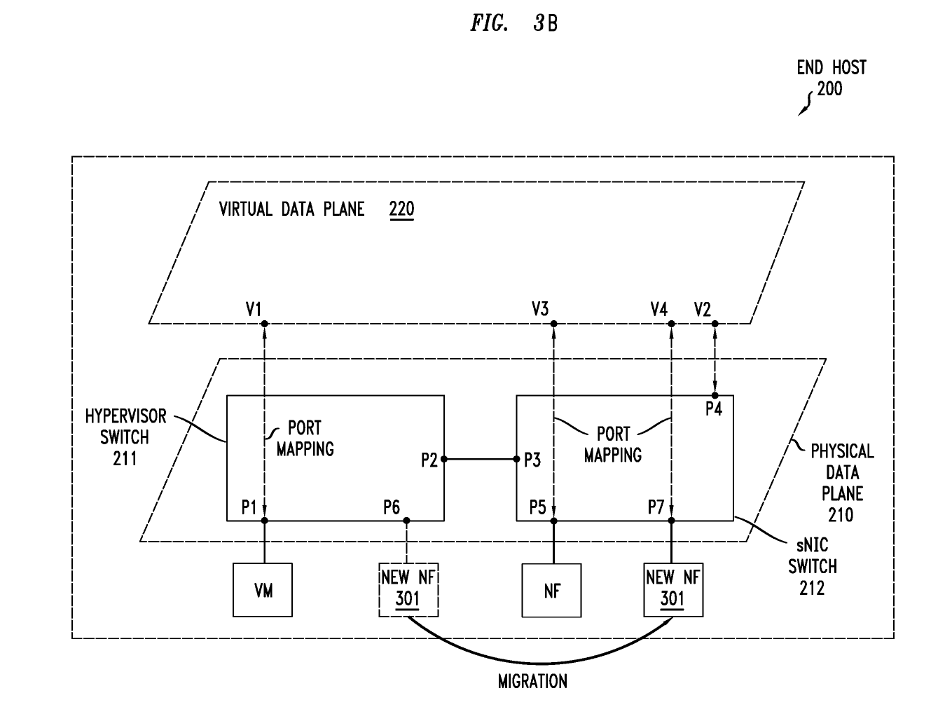

The NFA 125 and VS 126 of EH 110 may cooperate to keep packet processing offload hidden from various higher level management and control plane elements (e.g. NFA 125 of the EH 110 may be configured to provide virtualized management plane operations to abstract from NFC 151 the locations at which the NF instances are deployed (whether placed there initially or migrated there)). It is noted that operation of NFA 125 and VS 126 in supporting placement and migration of NF instances may be further understood by way of reference to FIGS. 3A-3B, which provide specific examples of port mapping creation and rule translation operations performed for NF deployment and NF migration scenarios.

The NFA 125 is configured to control instantiation of NF instances within EH 110. The NFA 125 is configured to receive from the NFC 151 a request for instantiation of an NF instance within EH 110, select a deployment location for the NF instance, and instantiate the NF instance at the deployment location selected for the NF instance. The deployment location for the NF instance may be the hypervisor 120 of EH 110 (e.g., similar to NF 123) where sNIC offload is not being used for the NF instance or the sNIC 130 of EH 110 (e.g., similar to NFs 133) where sNIC offload is being used for the NF instance. The NFA 125 may select the deployment location for the NF instance based on at least one of resource utilization information from RM 124 of EH 110, inter-switch communication link bandwidth utilization information of the EH 110 (e.g., PCI bus bandwidth utilization where the communication link between the HS 121 of hypervisor 120 and the SS 131 of sNIC 130 is a PCI bus) associated with the EH 110, capabilities of the sNIC 130 that is available for NF instance offload, or the like, as well as various combinations thereof. The resource utilization information from RM 124 of EH 110 may include one or more of resource utilization information of the hypervisor 120, resource utilization information of the sNIC 130, or the like, as well as various combinations thereof. The PCI bus bandwidth utilization of the EH 110 may be indicative of PCI bus bandwidth utilized by one or more tenant VMs of the EH 110 (illustratively, VMs 122) to communicate with external entities, PCI bus bandwidth utilized by NF instances which are deployed either on the hypervisor 120 or the sNIC 103 to communicate with one another across PCI bus, or the like, as various combinations thereof. The capabilities of the sNIC 130 that is available for NF instance offload may include hardware assist capabilities or other suitable types of capabilities. The NFA 125 may be configured to instantiate the NF instance at the deployment location selected for the NF instance using any suitable mechanism for instantiation of an NF instance within an end host. The NFA 125 may be configured to provide various other operations to control instantiation of NF instances within EH 110.

The NFA 125 is configured to control connection of NF instances within EH 110 to support communications by the NF instances. The NFA 125, after instantiating an NF instance at a deployment location within EH 110, may create a port mapping for the NF instance that is configured to hide the deployment location of the NF instance from the NFC 151 of IM 150. The NFA 125 may create the port mapping for the NF instance based on a virtual data plane supported by the EH 110. The port mapping that is created is a mapping between (1) the physical port for the NF instance (namely, the physical port of the end host switch to which the NF instance is connected when instantiated, which will be the HS 121 when the NF instance is instantiated on the hypervisor 120 and the SS 131 when the NF instance is instantiated on the sNIC 130) and (2) the virtual port of the virtual data plane with which the NF instance is associated. The NFA 125, after instantiating the NF instance on the EH 110 and connecting the NF instance within EH 110 to support communications by the NF instance, may report the instantiation of the NF instance to the NFC 151. The NFA 125, however, rather than reporting to the NFC 151 the physical port to which the NF instance was connected, only reports to the NFC 151 the virtual port of the virtual data plane with which the NF instance is associated (thereby hiding, from NFC 151, the physical port to which the NF instance was connected and, thus, hiding the packet processing offloading from the NFC 151).

The NFA 125 is configured to support configuration of VS 126 based on instantiation of NF instances within EH 110. The NFA 125 may be configured to support configuration of VS 126, based on the instantiation of NF instances within EH 110, based on management plane policies. The NFA 125 may be configured to support configuration of VS 126, based on instantiation of an NF instance within EH 110, by providing to VS 126 the port mapping created by the NFA 125 in conjunction with instantiation of the NF instance within EH 110. As discussed above, the port mapping is a mapping between (1) the physical port for the NF instance (namely, the physical port of the end host switch to which the NF instance is connected when instantiated, which will be the HS 121 when the NF instance is instantiated on the hypervisor 120 and the SS 131 when the NF instance is instantiated on the sNIC 130) and (2) the virtual port of the virtual data plane with which the NF instance is associated. This port mapping for the NF instance may be used by VS 126 to perform one or more rule translations for translating one or more virtual flow rules (e.g., based on virtual ports reported to IM 151 by NFA 125 when NFs are instantiated, virtual ports reported to IM 151 when tenant VMs are instantiated on EH 110, or the like) into one or more actual flow rules (e.g., based on physical ports of the end host switches to which the relevant elements, tenant VMs and NF instances, are connected) that are installed into one or more end host switches (illustratively, HS 121 and/or SS 131) by the VS 126. The VS 126 may perform rule translations when virtual flow rules are received by EH 110 from SDNC 155, when port mapping information is updated based on migration of elements (e.g., tenant VMs and NF instances) within the EH 110 (where such translations may be referred to herein as remapping operations), or the like, as well as various combinations thereof. It will be appreciated that a rule translation for translating a virtual flow rule into an actual flow rule may be configured to ensure that processing results from application of the actual flow rule are semantically equivalent to processing results from application of the virtual flow rule. The operation of VS 126 is performing such rule translations for flow rules is discussed further below. The NFA 125 may be configured to provide various other operations to configure VS 126 based on instantiation of NF instances within EH 110.

The NFA 125 also is configured to support migrations of NF instances (along with their internal states) within EH 110 in a manner that is hidden from to NFC 151. The NFA 125, based on a determination that an existing NF instance is to be migrated (e.g., within the hypervisor 120, from the hypervisor 120 to the sNIC 130 in order to utilize packet processing offload, from the sNIC 130 to the hypervisor 120 in order to remove use of packet processing offload, within the sNIC 130, or the like), may perform the migration at the EH 110 without reporting the migration to the NFC 151. The NFA 125, after completing the migration of the NF instance within EH 110 (such that it is instantiated at the desired migration location and connected to the underlying switch of EH 110 that is associated with the migration location), may update the port mapping that was previously created for the NF instance by changing the physical port of the port mapping while keeping the virtual port of the port mapping unchanged. Here, since the virtual port of the port mapping remains unchanged after the migration of the NF instance, NFA 125 does not need to report the migration of the NF instance to NFC 151 (the NFC 151 still sees the NF instance as being associated with the same port, not knowing that it is a virtual port and that the underlying physical port and physical placement of the NF instance have changed). The NFA 125, after completing the migration of the NF instance within EH 110 and updating the port mapping of the NF instance to reflect the migration, may provide the updated port mapping to the VS 126 for use by the VS 126 to perform rule translations for translating virtual flow rules received from SDNC 155 (e.g., which are based on virtual ports reported to IM 151 by NFA 125 when NFs are instantiated and virtual ports reported to IM 151 when tenant VMs are instantiated on EH 110) into actual flow rules that are installed into the end host switches (illustratively, HS 121 and SS 131) by the VS 126 (e.g., which are based on physical ports of the end host switches to which the relevant elements, tenant VMs and NF instances, are connected). The NFA 125 may be configured to support various other operations in order to support migrations of NF instances within EH 110 in a manner that is hidden from NFC 151.

The NFA 125 may be configured to provide various other virtualized management plane operations to abstract from NFC 151 the locations at which the NF instances are placed. The NFA 125 may be configured to make the northbound management plane agnostic to where (e.g., at the hypervisor 120 or the sNIC 130) the NF instances are deployed on the EH 110; however, while the northbound management plane interface of NFA 125 may remain unchanged (e.g., using a configuration as in OpenStack), the internal design of NFA 125 and the southbound switch configuration of NFA 125 may be significantly different from existing network function agent modules due to the packet processing offload intelligence added to NFA 125.

It is noted that, although omitted for purposes of clarity, the NFA 125 (or other element of EH 110) may be configured to provide similar operations when a tenant VM is instantiated (e.g., creating a port mapping between a physical port to which the tenant VM is connected and a virtual port of the virtual data plane that is supported by the EH 110 and only reporting the virtual port on the northbound interface(s) while also providing the port mapping to the VS 126 for use by the VS 126 in performing one or more rule translations for translating one or more virtual flow rules into one or more actual flow rules that are installed into one or more end host switches (illustratively, HS 121 and/or SS 131) by the VS 126).

The NFA 125 may be configured to provide various other operations and advantages and potential advantages.

The VS 126 of EH 110 may be configured to provide virtualized control plane operations to hide the multiple switches (namely, HS 121 and the SS 131) from SDNC 155 when controlling communications of EH 110.

The VS 126 is configured to construct the virtual data plane at the EH 110. The VS 126 receives, from the NFA 125, port mappings created by the NFA 125 in conjunction with instantiation of NF instances within EH 110. As discussed above, a port mapping for an NF instance is a mapping between (1) the physical port for the NF instance (namely, the physical port of the end host switch to which the NF instance is connected when instantiated, which will be the HS 121 when the NF instance is instantiated on the hypervisor 120 and the SS 131 when the NF instance is instantiated on the sNIC 130) and (2) the virtual port of the virtual data plane with which the NF instance is associated. It is noted that, although omitted for purposes of clarity, the VS 126 may receive from the NFA 125 (or one or more other elements of EH 110) port mappings created in conjunction with instantiation of tenant VMs within EH 110 (again, mappings between physical ports to which the tenant VMs are connected and virtual ports of the virtual data plane with which the tenant VMs are associated, respectively). It is noted that, although omitted for purposes of clarity, the VS 126 may receive from the NFA 125 (or one or more other elements of EH 110) port mappings for other types of physical ports supported by EH 110 (e.g., physical ports between HS 121 and SS 131, physical ports via which communications leaving or entering the EH 110 may be sent, or the like). The VS 126 is configured to construct the virtual data plane at the EH 110 based on the received port mappings (e.g., maintaining the port mappings provides the virtual data plane in terms of providing information indicative of the relationships between the physical ports of the end host switches of EH 110 and the virtual ports of the virtual data plane of EH 110).

The VS 126 is configured to use the virtual data plane at the EH 110 to perform rule translations for flow rules to be supported by EH 110. The VS 126 may receive flow rules from SDNC 155. The received flow rules are specified in terms of virtual ports of the virtual data plane of EH 110, rather than physical ports of the end host switches of EH 110, because the NFA 125 (and possibly other elements of EH 110) hide the physical port information from the IM 150. The flow rules may include various types of flow rules supported by SDNC 155, which control the communications of tenant VMs and associated NF instances (including communication among tenant VMs and associated NF instances), such as flow forwarding rules, packet modification rules, or the like, as well as various combinations thereof. The packet modification rules may include packet tagging rules. It is noted that packet tagging rules may be useful or necessary when an ingress port and an egress port of a virtual rule are mapped to two different physical switches, since traffic at the switch of the ingress port may be used so that ingress port information can be carried across the different switches (without such tagging, traffic originating from multiple different ingress ports cannot be distinguished properly). The VS 126 is configured to receive a flow rule from SDNC 155, perform a rule translation for the flow rule in order to translate the virtual flow rule received from SDNC 155 (e.g., which is based on virtual ports reported to IM 151 by NFA 125 when NFs are instantiated and virtual ports reported to IM 151 when tenant VMs are instantiated on EH 110) into one or more actual flow rules for use by one or more end host switches (illustratively, HS 121 and/or SS 131), and install the one or more actual flow rules in the one or more end host switches (again, HS 121 and/or SS 131). The VS 126 is configured to receive an indication of an element migration event in which an element (e.g., a tenant VM, an NF instance, or the like) is migrated between physical ports and perform a rule remapping operation for the migrated element where the rule remapping operation may include removing one or more existing actual flow rules associated with the migrated element from one or end host switches (e.g., from an end host switch to which the element was connected prior to migration), re-translating one or more virtual flow rules associated with the migrated element into one or more new actual flow rules for the migrated element, and installing the one or more new actual flow rules for the migrated element into one or more end host switches (e.g., to an end host switch to which the element is connected after migration). The VS 126 may be configured to perform rule translations while also taking into account other types of information (e.g., the ability of the flow rule to be offloaded (which may depend on the rule type of the rule), resource monitoring information from RM 124, or the like, as well as various combinations thereof).

The VS 126, as noted above, is configured to construct the virtual data plane at the EH 110 and is configured to use the virtual data plane at the EH 110 to perform rule translations. The VS 126 may be configured in various ways to provide such operations. The VS 126 may be configured to construct a single virtual data plane using the virtual ports created by NFA 125, and to control the end host switches (again, HS 121 and SS 131) by proxying as a controller for the end host switches (since the actual physical configuration of the end host switches is hidden from IM 150 by the virtual data plane and the virtual management and control plane operations provided by NFA 125 and VS 126). The VS 126 may maintain the port mappings (between virtual ports (visible to IM 150) and physical ports (created at the end host switches)) in a port-map data structure or set of data structures. The VS 126 may maintain the rule mappings (between virtual rules (provided by IM 150) and the actual rules (installed at the end host switches)) in a rule-map data structure or set of data structures.

The VS 126 may be configured to perform rule translations in various ways. The VS 126 may be configured to perform rule translations using (1) virtual-to-physical port mappings and (2) switch topology information that is indicative as to the manner in which the switches of EH 110 (again, HS 121 and SS 131) are interconnected locally within EH 110. The VS 126 may be configured to perform a rule translation for a given virtual rule (inport, outport)by (a) identifying (in-switch, out-switch), where “in-switch” is a physical switch to which inport is mapped and “out-switch” is a physical switch to which outport is mapped, (b) determining whether “in-switch” and “out-switch” match (i.e., determining whether in-switch ==out-switch), and (c) performing the rule translation for the given virtual rule based on the result of the determination as to whether in-switch” and “out-switch” are the same switch. If in-switch==out-switch, then VS 126 performs the rule translation of the given virtual rule as (physical-inport, physical-outport). If in-switch !=out-switch, then the VS 126 constructs a routing path from in-switch to out-switch (and generates a physical forwarding rule on each intermediate switch along the path from the ingress switch to the egress switch). The VS 126 may be configured to perform rule translations in various other ways.

The VS 126 may be configured to perform port/rule remapping in various ways. Here, for purposes of clarity, assume that an NF connected to physical port X at switch i is being migrated to physical port Y at switch j and, further, assume that the externally visible virtual port U is mapped to physical port X prior to migration of the NF. Additionally, let RO represent a set of all of the virtual rules that are associated with virtual port U prior to migration of the NF. Once the NF migration is initiated, a new NF instance is launched and connected at physical port Y at switch j and the external visible virtual port U is then remapped from physical port X of switch I to physical port Y of switch j. The VS 126 identifies all actual rules that were initially translated based on RO and removes those actual rules from the physical switches. The NF state of the NF instance is then transferred from the old NF instance to the new NF instance. The VS 126 then retranslates each of the virtual rules in RO to form newly translated actual rules which are then installed on the appropriate physical switches. The VS 126 may be configured to perform port/rule remapping in various other ways.

The VS 126 of EH 110 may be configured to provide various other virtualized control plane operations to hide the multiple switches (namely, HS 121 and SS 131) from SDNC 155 when controlling communications of EH 110.

The VS 126 of EH 110 may be configured to provide various other control plane operations (e.g., exporting traffic statistics associated with virtual flow rules and virtual ports or the like)

The VS 126 may be configured to provide various other operations and advantages and potential advantages.

The NFA 125 and VS 126 may be configured to cooperate to provide various other virtualized management plane and control plane operations which may be used to render the sNIC data plane offload hidden from external controllers (illustratively, IM 150).

It will be appreciated that, although primarily presented within the context of a datacenter system including a single end host (illustratively, EH 110), various datacenter systems are expected to have large numbers of end hosts (some or all of which may be configured to support embodiments of the packet processing offload support capabilities). It will be appreciated that, although primarily presented within the context of an end host including a single sNIC, various end hosts may include multiple sNICs (some or all of which may be configured to support embodiments of the packet processing offload support capabilities). It is noted that other modifications to exemplary datacenter system 100 of FIG. 1 are contemplated.

FIG. 2 depicts an exemplary end host including a physical data plane and including a virtual data plane that is configured for use in transparently supporting packet processing offload in the physical data plane of the end host.

The end host (EH) 200 includes a physical data plane (PDP) 210 and an associated virtual data plane (VDP) 220.

The PDP 210 includes a hypervisor switch (HS) 211 (e.g., similar to HS 121 of hypervisor 120 of FIG. 1) and an sNIC switch (SS) 212 (e.g., similar to SS 131 of sNIC 130 of FIG. 1).

The HS 211 supports a number of physical ports. The HS 211 supports physical ports to which processing elements (e.g., tenant VMs, NF instances, or the like) may be connected (illustratively, physical port P1 connects a tenant VM to the HS 211). The HS 211 also includes one or more physical ports which may be used to connect the HS 211 to the SS 212 in order to support communications between the associated hypervisor and sNIC (illustratively, physical port P2). The HS 211 may include other physical ports.

The SS 212 supports a number of physical ports. The SS 212 includes one or more physical ports which may be used to connect the SS 212 to the HS 211 to support communications between the associated sNIC and hypervisor (illustratively, physical port P3). The SS 212 also includes one or more physical ports which may be used for communications external to the EH 200 (illustratively, physical port P4). The SS 212 also includes physical ports to which processing elements (e.g., NF instances for packet processing offload) may be connected (illustratively, physical port P5 connects an NF instance to SS 212). The SS 212 may include other physical ports.

The VDP 220 includes a set of virtual ports. The virtual ports are created at the EH 200 (e.g., by the NFA of EH 200), and the EH 200 establishes and maintains port mappings between the virtual ports of the VDP 220 and the physical ports of the PDP 210. The physical port P1 of HS 211 is mapped to an associated virtual port V1 of the VDP 220. The physical port P4 of SS 212 is mapped to an associated virtual port V2 of the VDP 220. The physical port P5 of SS 212 is mapped to an associated virtual port V3 of the VDP 220.

The EH 200 is configured to use the VDP 220 in order to provide a virtualized management plane and control plane. The EH 200 is configured to expose the VDP 220, rather than the PDP 210, to upstream systems that are providing management and control operations for EH 200. This enables the upstream systems for the EH 200 to operate on the VDP 220 of the EH 200, believing it to be the PDP 210 of the EH 200, while the EH 200 provides corresponding management and control of the PDP 210 of EH 200. This keeps the existence of the sNIC, as well as details of its configuration, hidden from the upstream systems. This also keeps packet processing offload hidden from the upstream systems. This enables the EH 200 to control packet processing offload locally without impacting the upstream systems.

FIGS. 3A-3B depict exemplary NF instance deployment and migration scenarios within the context of the exemplary end host of FIG. 2 for illustrating use of the virtual data plane of the end host to transparently supporting packet processing offload in the physical data plane of the end host.

FIG. 3A depicts an exemplary NF instance deployment within the context of the EH 200 of FIG. 2, for illustrating use of the VDP 220 of the EH 200 to transparently support packet processing offload in the PDP 210 of the EH 200. Here, it is assumed that the NFA of EH 200 (omitted for purposes of clarity) receives from an upstream controller a request for instantiation of a new NF instance for a tenant VM connected to the virtual port V1 on the VDP 220, instantiates a new NF 301 for the tenant VM connected to the physical port P1 of the HS 211, connects the new NF 301 to a physical port P6 of the HS 211 (i.e., packet processing offload is not used), creates a virtual port V4 in the VDP 220 for the new NF 301, creates a port mapping that maps the virtual port V4 for the new NF 301 to the physical port P6 of the new NF 301 (denoted as port mapping (V4:P6)), provides the port mapping (V4:P6) to the VS of EH 200, and provides virtual port V4 to the upstream controller (also omitted for purposes of clarity) such that the physical port P6 is hidden from the upstream controller. In this example, assume that the VS of the EH 200 also has a port mapping for the tenant VM (V1:P1) for which the new NF 301 was instantiated. In this example, assume that the VS of EH 200 receives, from an upstream controller (e.g., SDNC 155 of IM 150 of FIG. 1), a virtual flow forwarding rule (V4→V1) for controlling forwarding of packets from the new NF 301 to the tenant VM. The VS of the EH 200, based on the two port mappings for the new NF 301 and the tenant VM, translates the virtual flow forwarding rule (V4→V1) into a corresponding actual flow forwarding rule (P6→P1) and installs the actual flow forwarding rule (P6→P1) onto the hypervisor switch 211 such that hypervisor switch 211 can use the actual flow forwarding rule (P6→P1) to control forwarding of packets from the new NF 301 to the tenant VM. This translation from the virtual flow forwarding rule (V4→V1) to the actual flow forwarding rule (P6→P1) enables the physical configuration of the EH 200 to remain hidden from the upstream controller.

FIG. 3B depicts an exemplary NF instance migration within the context of the EH 200 of FIG. 2, for illustrating use of the VDP 220 of the EH 200 to transparently support packet processing offload in the PDP 210 of the EH 200. Here, it is assumed that the NFA of the EH 200 (which, again, is omitted for purposes of clarity) decides to migrate the new NF 301, for the tenant VM connected to physical port P1 of the HS 211, within EH 200 (e.g., based on resource usage of the hypervisor of the EH 200). The NFA of the EH 200 migrates the new NF 301 from being connected to the physical port P6 of the HS 211 to being connected to a physical port P7 of the SS 212 (i.e., packet processing offload is used), updates the existing port mapping (V4:P6) for the new NF 301 to provide an updated port mapping (V4:P7) for the new NF 301, and provides the updated port mapping (V4:P7) to the VS of the EH 200 (which, again, is omitted for purposes of clarity). It is noted that this migration may be performed by the EH 200 without updating the upstream controller since the virtual port of the new NF 301 (previously reported to the upstream controller when the new NF 301 was first instantiated) has not changed. In this example, assume that the VS of the EH 200 also has information describing a physical connection between a physical port of the HS 211 (physical port P2) and a physical port of the SS 212 (physical port P3). The VS of the EH 200, based on receipt of the updated port mapping (V4:P7) for the new NF 301, uninstalls the existing actual flow forward rule(s) for the new NF 301 (namely, actual flow forwarding rule (P6→P1) presented with respect to FIG. 3A) and translates the virtual flow forwarding rule (V4→V1) for new NF 301 into new actual flow forwarding rule(s) for the new NF 301 (depicted with respect to FIG. 3B). The VS of the EH 200, based on the updated port mapping (V4:P7) for the new NF 301, the port mapping for the tenant VM (V1:P1), knowledge of the physical connection (P2 P3) between the HS 211 and the SS 212, translates the virtual flow forwarding rule (V4→V1) into two new actual flow forwarding rules which are installed as follows: (1) an actual flow forwarding rule (P7→TAG P7 & P3), to support forwarding of packets from new NF 301 to the physical port on SS 212 via which the HS 211 may be accessed (namely, P3) and to support tagging of the packets with an identifier of P7 as this will be used as part of the match condition by HS 211 to identify packets of the flow, which is installed on SS 212 such that SS 212 uses the actual flow forwarding rule (P7→TAG P7 & P3) to support forwarding of packets from the new NF 301 toward the HS 211 for delivery to the tenant VM and (2) an actual flow forwarding rule (P2 & TAG==P7→UNTAG & P1), to support removal of the identifier of P7 from the packets of the flow as this tag is no longer needed once the packets are matched at HS 211 and to support forwarding of packets from the access point into the HS 211 from the SS 212 (namely, P2) to the physical port of the HS 211 to which the tenant VM is connected, which is installed on HS 211 such that HS 211 can use the actual flow forwarding rule to support forwarding of packets to the tenant VM. As indicated above, TAG P7 and UNTAG are additional actions and TAG==P7 is an additional associated match condition which, together, ensure that, among the traffic flows entering HS 211 from P2, only those which originate from P7 on SS 212 will be matched and forwarded to P1. This translation from the virtual flow forwarding rule (V4→V1) to the set of actual flow forwarding rules (P7→TAG P7 & P3 and P2 & TAG==P7→UNTAG & P1) enables the physical configuration of the EH 200 (including offloading of the NF instance to the sNIC) to be hidden from the upstream controller. As a result, the northbound management and control plane remains unchanged before and after NF migration as the new NF 301 remains logically connected to virtual port V3 even though the underlying physical configuration has changed.

It will be appreciated that the examples of FIGS. 3A and 3B represent merely a few of the various potential physical configurations of tenant VMs and associated NFs and that port mappings and associated rule translations may be used to support various other physical configurations of tenant VMs and associated NFs as well as associated changes to physical configurations of tenant VMs and associated NFs.

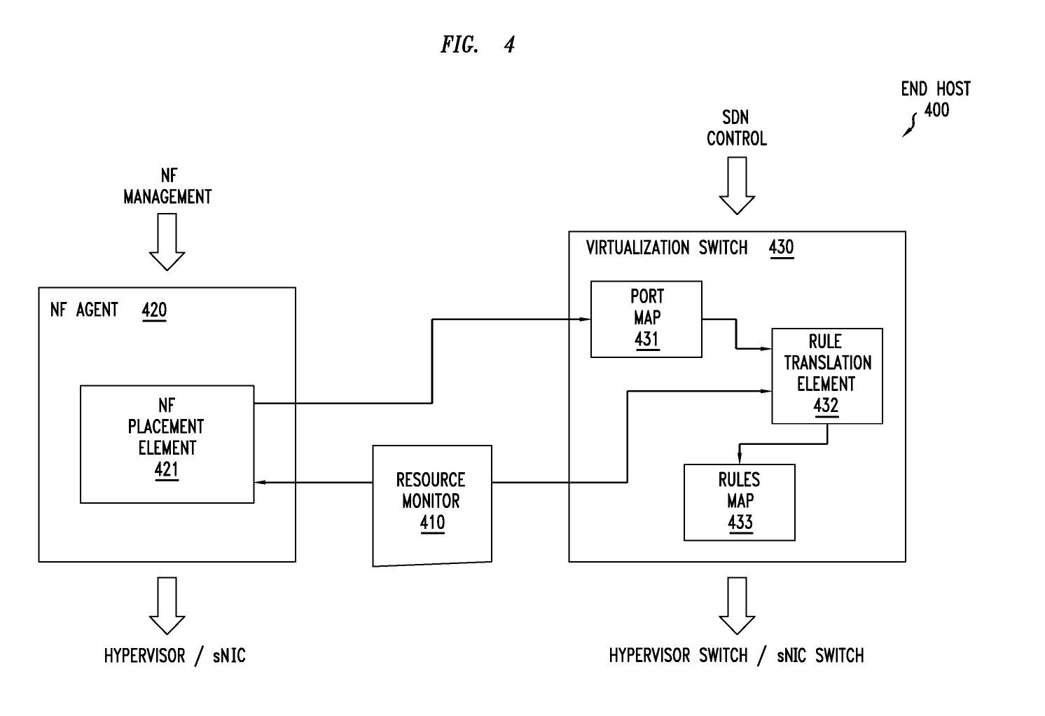

FIG. 4 depicts an exemplary end host including a network function agent and a virtualization switch which are configured to cooperate to support transparent packet processing offload.

The end host (EH) 400 includes a resource monitor (RM) 410 (which may be configured to support various operations presented herein as being performed by RM 124), a network function agent (NFA) 420 (which may be configured to support various operations presented herein as being performed by NFA 125), and a virtualization switch (VS) 430 (which may be configured to support various operations presented herein as being performed by VS 126).

The RM 410 is configured to perform resource monitoring at EH 400 and to provide resource monitoring information to NFA 420 and VS 430.

The NFA 420 includes an NF Placement Module (NPA) 421 that is configured to instantiate NFs at EH 400. The NPA 421 may be configured to determine that NFs are to be instantiated or migrated (e.g., based on requests from upstream management systems, locally based on resource monitoring information from RM 410, or the like, as well as various combinations thereof). The NPA 421 may be configured to determine the placement of NFs that are to be instantiated or migrated (e.g., based on resource monitoring information from RM 410 or other suitable types of information). The NPA 421 may be configured to initiate and control instantiation and migration of NFs at EH 400. The NPA 421 may be configured to (1) create virtual ports for NFs instantiated or migrated within EH 400 and (2) send indications of the virtual ports for NFs to upstream management systems. The NPA 421 may be configured to (1) create port mappings for NFs, between the virtual ports created for the NFs and the physical ports of switches of EH 400 to which the NFs are connected, for NF instantiated or migrated within EH 400 and (2) send indications of the port mappings to VS 430 for use by VS 430 in controlling switches of the EH 400 (e.g., the hypervisor switch, any sNIC switches of sNICS, or the like) by proxying as a controller for the switches of the EH 400. The NFA 420 of EH 400 may be configured to support various other operations presented herein as being supported by NFA 125 of FIG. 1.

The VS 430 includes a Port Map (PM) 431, a Rule Translation Element (RTE) 432, and a Rules Map (RM) 433.

The PM 431 includes port mapping information. The port mapping information of PM 431 may include port mappings, between virtual ports created for NFs by NFA 420 and the physical ports of switches of EH 400 to which the NFs are connected by NFA 420, which may be received from NFA 420. The port mapping information of PM 431 also may include additional port mappings which may be used by RTE 432 in performing rule translation operations (e.g., port mappings for tenant VMs of EH 400 for which NFs are provided, which may include port mappings between virtual ports created for tenant VMs of EH 400 and the physical ports of switches of EH 400 to which the tenant VMs are connected), although it will be appreciated that such additional port mappings also may be maintained by EH 400 separate from PM 431.

The RTE 432 is configured to support rule translation functions for translating flow rules associated with EH 400. In general, a flow rule includes a set of one or more match conditions and a set of one or more associated actions to be performed when the set of one or more match conditions is detected. The RTE 432 is configured to translate one or more virtual flow rules (each of which may be composed of a set of one or more match conditions and a set of one or more actions to be performed based on a determination that the set of match conditions is identified) into one or more actual flow rules (each of which may be composed of one or more match conditions and one or more actions to be performed based on a determination that the set of match conditions is identified). There are various categories of flow rules depending on whether the match condition(s) is port-based or non-port-based and depending on whether the action(s) is port-based or non-port-based. For example, given that a flow rule is represented with (match, action(s)), there are four possible categories of flow rules in terms of rule translations: (1) port-based match and port-based action(s), (2) non-port-based match and port-based action(s) (3) port-based match and non-port-based action(s) and (4) non-port-based match & non-port-based action(s). It will be appreciated that these various categories of flow rules may be true for both virtual flow rules (with respect to whether or not virtual ports are specified in the rules) and actual flow rules (with respect to whether or not physical ports are specified in the rules). It will be appreciated that one or more virtual flow rules may be translated into one or more actual flow rules (e.g., 1 to N, N to 1, N to N, or the like).

The RTE 432 is configured to translate virtual flow rules into actual flow rules for port-based flow rules (e.g., flow rules including port-based match conditions but non-port-based actions, flow rules including non-port-based match conditions but port-based actions, flow rules including port-based match conditions and port-based actions, or the like). The RTE 432 is configured to translate virtual flow rules (specified in terms of virtual ports of the virtual data plane of the EH 400) into actual flow rules (specified in terms of physical ports of the switches of physical elements of the EH 400), for port-based flow rules, based on port mapping information (illustratively, based on port mapping information of PM 431). The rule translations for translating virtual flow rules into actual flow rules may be performed in various ways, which may depend on whether the match conditions are port-based, whether the actions are port-based, or the like, as well as various combinations thereof. This may include translation of a virtual port-based match condition specified in terms of one or more virtual ports into an actual port-based match condition specified in terms of one or more physical ports, translation of a virtual port-based action specified in terms of one or more virtual ports into an actual port-based action specified in terms of one or more physical ports, or the like, as well as various combinations thereof. As indicated above and discussed further below, port mapping information may be used in various ways to perform rule translation functions for translating various types of virtual flow rules into various types of actual flow rules.

The RTE 432 is configured to translate port-based virtual flow rules into port-based actual flow rules based on port mapping information. As noted above, the rule translations for translating virtual flow rules into actual flow rules may be performed in various ways, which may depend on whether the match conditions are port-based, whether the actions are port-based, or the like, as well as various combinations thereof. Examples of port-based rule translations in which the match conditions and actions are both port-based are presented with respect to FIGS. 3A and 3B. Additionally, an example of a port-based rule translation of a flow rule where the match conditions are non-port-based and the actions are port-based follows. In this example, assume a virtual flow rule of if dest-IP=X, send traffic to port Y (where port Y is a virtual port). This virtual flow rule is first translated into a union of port-based virtual flow rules: (1) dest-IP=X & inPort=1, send traffic to port Y, (2) dest-IP=X & inPort=2, send traffic to port Y, and so forth until (N) dest-IP=X & inPort=N, send traffic to port Y. Here, in the port-based virtual flow rules Ports 1-N are the list of existing virtual ports. The port-based virtual flow rules are then translated, based on port mapping information, into a corresponding set of actual flow rules such as: (1) dest-IP=X & inPort=P1, send traffic to port Y, (2) dest-IP=X & inPort=P2, send traffic to port Y, and so forth until (N) dest-IP=X & inPort=PN, send traffic to port Y (where P1-PN are the physical ports mapped to virtual ports 1-N, respectively). It will be appreciated that the examples of FIGS. 3A and 3B and the example described above are merely a few of the many ways in which rule translations may be performed, which may vary within the categories of rule translations discussed above, across different categories of rule translations discussed above, or the like.

The RTE 432 may be configured to translate virtual flow rules into actual flow rules based on use of additional metadata within the actual flow rules. The additional metadata for an actual flow rule may be included as part of the match condition(s) of the actual flow rule, as part of the action(s) of the actual flow rule, or both. The additional metadata may be in the form of traffic tagging (e.g., as depicted and described with respect to the example of FIG. 3B) or other suitable types of metadata which may be used as matching conditions and/or actions in flow rules.

The RTE 432 may be configured to translate virtual flow rules into actual flow rules based on additional information in addition to the port mapping information. The additional information may include resource utilization information (illustratively, based on information from RM 410) or other suitable types of information.

The RTE 432 may be configured to determine the deployment locations for non-port-based actual flow rules (e.g., packet header modifications rules or the like). The RTE 432 may be configured to select, for non-port-based actual flow rules, the switch on which the non-port-based actual flow rules will be applied and to install the non-port-based actual flow rules on the selected switch. This may be the hypervisor switch or the sNIC switch. The RTE 432 may be configured to determine the deployment locations for non-port-based actual flow rules based on the additional information described herein as being used for port translation (e.g., resource utilization information or the like). For example, RTE 432 may be configured to select a least-loaded (most-idle) switch as the deployment location for a non-port-based actual flow rule.

The RM 433 includes rule mapping information. The rule mapping information includes mappings between virtual flow rules (which are known to upstream control systems) and actual flow rules (which are not known to upstream control systems, but, rather, which are only known locally on the EH 400).

The VS 430 is configured to control configuration of switches of EH 400 (e.g., the hypervisor switch and one or more sNIC switches) based on RM 433. The VS 430 may be configured to control configuration of switches of EH 400 by installing actual flow rules onto the switches of EH 400 for use by the switches of EH 400 to perform flow operations for supporting communications of the EH 400. The VS 430 of EH 400 may be configured to support various other control plane operations presented herein as being supported by VS 126 of FIG. 1 (e.g., exporting traffic statistics associated with virtual flow rules and virtual ports). The VS 430 of EH 400 may be configured to support various other operations presented herein as being supported by VS 126 of FIG. 1.

It is noted that the NFA 420 and the VS 430 may be configured to support various other operations presented herein as being supported by NFA 125 and VS 126 of FIG. 1, respectively.

It will be appreciated that, although primarily presented herein with respect to embodiments in which transparent packet processing offload functions are applied to network functions of the end host, transparent packet processing offload functions also may be applied to tenant resources of the end host.

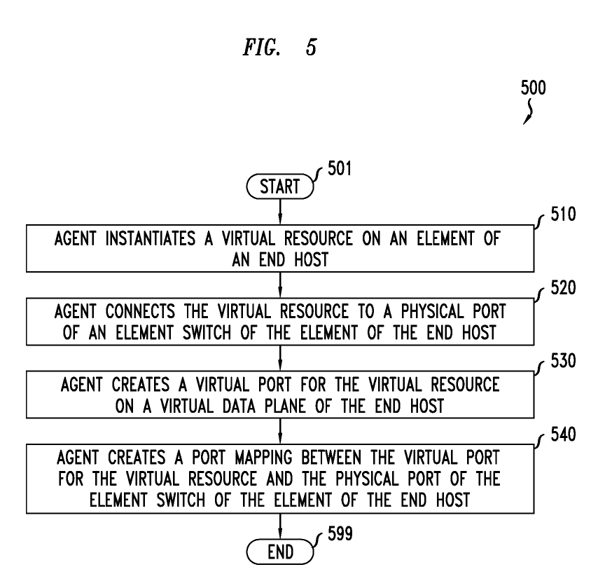

FIG. 5 depicts an exemplary embodiment of a method for use by an agent of an end host to hide details of the physical data plane of the end host. It will be appreciated that, although primarily presented as being performed serially, at least a portion of the operations of method 500 may be performed contemporaneously or in a different order than as presented in FIG. 5. It will be appreciated that the operations of method 500 of FIG. 5 may be a subset of the operations which may be performed by the agent of an end host to hide details of the physical data plane of the end host and, thus, that various other methods implementing various other combinations of agent operations may be supported (e.g., various processes supporting various operations of NFA 125 of FIG. 1 and/or NFA 420 of FIG. 4 may be supported).

At block 501, method 500 begins.

At block 510, the agent instantiates a virtual resource on an element of an end host. The virtual resource may be instantiated to support a tenant resource, a network function, or the like. The virtual resource may be a VM, a VC, or the like. The agent may instantiate the virtual resource responsive to a request from a controller, based on a local determination to instantiate the virtual resource (e.g., an additional instance of an existing tenant resource, network function, or the like), or the like. The element of the end host may be a hypervisor of the end host or a processing offload device of the end host.

At block 520, the agent connects the virtual resource to a physical port of an element switch of the element of the end host.

At block 530, the agent creates a virtual port for the virtual resource on a virtual data plane of the end host. The virtual data plane is associated with a virtualization switch of the end host. The agent may provide an indication of the virtual port to a controller (e.g., a controller which requested instantiation of the virtual resource) without providing an indication of the physical port to the controller.

At block 540, the agent creates a port mapping between the virtual port for the virtual resource and the physical port of the element switch of the element of the end host. The agent may provide the port mapping to the virtualization switch of the end host for use in performing rule translations for translating virtual rules (which are based on the virtual port) into actual rules (which are based on the physical port) which may be installed onto and used by physical switches of the end host.

At block 599, method 500 ends.

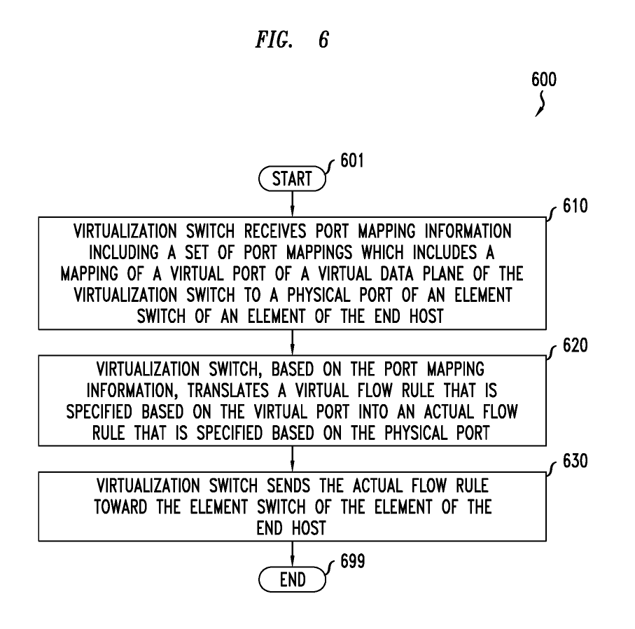

FIG. 6 depicts an exemplary embodiment of a method for use by a virtualization switch of an end host to hide details of the physical data plane of the end host. It will be appreciated that, although primarily presented as being performed serially, at least a portion of the operations of method 600 may be performed contemporaneously or in a different order than as presented in FIG. 6. It will be appreciated that the operations of method 600 of FIG. 6 may be a subset of the operations which may be performed by the virtualization switch of an end host to hide details of the physical data plane of the end host and, thus, that various other methods implementing various other combinations of virtualization switch operations may be supported (e.g., various processes supporting various operations of VS 126 of FIG. 1 and/or VS 430 of FIG. 4 may be supported).

At block 601, method 600 begins.

At block 610, the virtualization switch receives port mapping information. The port mapping information includes a set of port mappings which includes a mapping of a virtual port of the virtual data plane of the virtualization switch to a physical port of an element switch of an element of the end host. The element switch of the element of the end host may be a hypervisor switch of a hypervisor of the end host or a processing offload switch of a processing offload device of the end host.

At block 620, the virtualization switch, based on the port mapping information, translates a virtual flow rule into an actual flow rule. The virtual flow rule is specified based on the virtual port. The actual flow rule is specified based on the physical port. The virtual flow rule may be received from a controller, which may have received an indication of the virtual port from an agent of the end host from which the virtualization switch receives the port mapping information.

At block 630, the virtualization switch sends the actual flow rule toward the element switch of the element of the end host.

At block 699, method 600 ends.

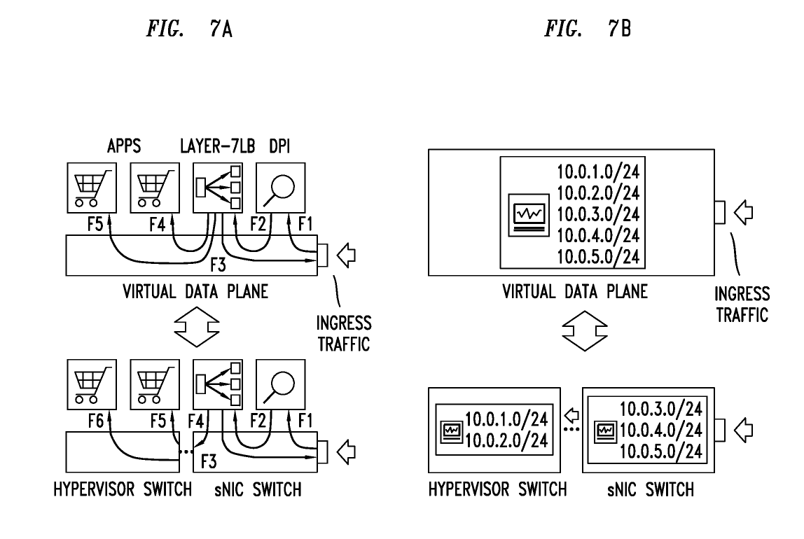

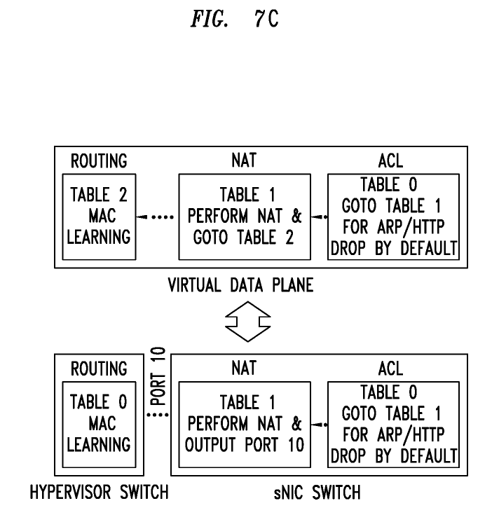

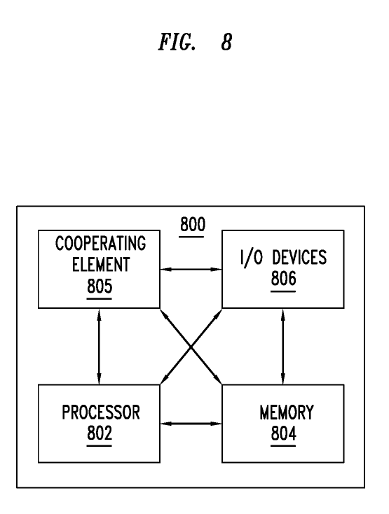

FIG. 7A-7C depict exemplary offload embodiments which may be realized based on embodiments of packet processing offload support capabilities.

FIG. 7A depicts an exemplary embodiment in which packet processing offload support capabilities may be used to support network function offload. This is similar to embodiments depicted and described with respect to FIGS. 1-6. In order to relieve host cores of end hosts, packet processing offload support capabilities can be used to transparently offload compute-intensive NFs from the hypervisor of the host to the sNIC. An example is depicted in FIG. 7A, in which a virtual data plane interconnects a deep packet inspection (DPI) NF and a layer-7 (L7) load balancer (L7LB) NF and two tenant application (e.g., e-commerce) instances. The traffic flows in the virtual data plane are indicated with F1-F5. Given incoming traffic (“F1”), the DPI NF extracts HTTP cookies and sends them (along with traffic) to the L7LB function (“F2”) as NF-specific metadata. The L7LB translates customer-facing virtual IP addresses in the traffic to the physical IP addresses of e-commerce applications, based on user cookies. Finally, traffic is forwarded to e-commerce applications based on physical IP addresses (“F4” and “F5” for local instances, and “F3” for any remote instances). The virtual data plane can be mapped to two physical data planes, as depicted in bottom portion of FIG. 7A. The DPI and L7LB NFs are chained via the sNIC switch, while tenant applications are connected to the hypervisor switch. The flow rules F4 and F5 on the virtual data plane are translated to flow rules F4, F5, and F6 on the hypervisor and sNIC switches. In this manner, the offloaded DPI NF can benefit from the built-in hardware DPI engine of the sNIC (e.g., Cavium OCTEON). The L7LB NF can be deployed either at the hypervisor or at the sNIC if it serves only co-located local applications; however, if the L7LB NF serves any remote application instances (as in FIG. 7A), it may be better to deploy the L7LB on the sNIC in order to prevent traffic from traversing the PCI bus multiple times. This illustrates a case in which the NF placement decision is affected by communication patterns of NFs and tenant applications.

FIG. 7B depicts an exemplary embodiment in which packet processing offload support capabilities may be used to support flow rules offload. It is noted that flow rules offload may be motivated by the increasing number of fine-grained management policies employed in data centers for various purposes (e.g., access control, rate limiting, monitoring, or the like) and associated high CPU overhead in processing such rules. When it comes to flow rule offload, however, it should be noted that certain flow rules may be offloadable while other flow rules may not be offloadable. Accordingly, before offloading flow rules, the various flow rules may need to be checked to determine whether or not they are offloadable. For example, flow rules for flow-rule based network monitoring, where network traffic is classified and monitored based on packet header fields, may be offloaded. It is noted that monitoring rules can be offloaded, because such rules are decoupled from routing/forwarding rules which may be tied to tenant applications running on the hypervisor. As depicted in FIG. 7B, the packet processing offload support capabilities may enable partitioning of monitoring rules into the hypervisor switch and the sNIC switch, while keeping a unified northbound control plane that combines flow statistics from the hypervisor and sNIC switches. Additionally, it is noted that various sNICs (e.g., Mellanox TILE-Gx or the like) may provide opportunities to parallelize flow rule processing on multicores via use of fully programmable hardware-based packet classifiers.

FIG. 7C depicts an exemplary embodiment in which packet processing offload support capabilities may be used to support multi-table offload. Modern SDN switches, like OVS, support pipelined packet processing via multiple flow tables. Multi-table support enables modularized packet processing within a switch, by which each flow table implements a logically separable function (e.g., filtering, tunneling, NAT, routing, or the like). This also helps avoid cross-product rule explosion. However, a long packet processing pipeline typically comes with the cost of increased per-packet table lookup operations. While OVS addresses the issue with intelligent flow caching, a long pipeline cannot be avoided with caching if a bulk of network flows are short-lived. In this environment, some of the tables can be offloaded to the sNIC switch, as long as the flow rules in the tables are offloadable, and the inter-switch PCI communication can carry any metadata exchanged between split flow tables. As depicted in FIG. 7C, for example, packet filtering and modification rules in ACL/NAT tables can be safely migrated to the sNIC switch, thereby shortening the main processing pipeline in the hypervisor switch.

In at least some embodiments, packet processing offload support capabilities may be used in systematic chaining of multiple hardware offloads. Hosting enterprise traffic in multi-tenant data centers often involves traffic isolation through encapsulation (e.g., using VxLAN, Geneve, GRE, or the like) and security or data compression requirements such as IPsec or de-duplication. These operations may well be chained one after another, e.g., VxLAN encapsulation followed by an outer IPsec tunnel. While tunneling, cryptographic, and compression operations are well supported in software, they could incur a significant toll on host CPUs, even with special hardware instructions (e.g., Intel AES-NI). Alternatively, it is possible to leverage hardware offloads available in commodity NICs, such as large packet aggregation or segmentation (e.g., LRO/LSO) and inner/outer protocol checksum for tunneling. There are also standalone hardware assist cards (e.g. Intel QAT) which can accelerate cryptographic and compression operations over PCI. However, pipelining these multiple offload operations presents various challenges, not only because simple chaining of hardware offloads leads to multiple PCI bus crossings/interrupts, but also because different offloads may stand at odds with one another when they reside on separate hardware. For example, a NIC's VxLAN offload probably cannot be used along with cryptographic hardware assistance as it does not work in the request/response mode as cryptographic offload. Also, segmentation on ESP packets of IPsec is often not supported in hardware, necessitating software-based large packet segmentation before cryptographic hardware assist. It is noted that these restrictions lead to under-utilization of individual hardware offload capacities. Many sNICs have integrated hardware circuitry for cryptographic, compression operations, as well as tunnel processing, thereby making them an ideal candidate for a unified hardware offload pipeline. With a fully-programmable software switch running on sNIC, various embodiments of the packet processing offload support capabilities may allow multiple offloaded operations to be pipelined in a flexible manner at the flow level. It will be appreciated that, if certain hardware offload features are not supported, software operations can always be used instead, either using sNIC cores or host CPUs (e.g., replacing LSO with kernel GSO at the host or sNIC, as appropriate), under the control of packet processing offload support capabilities.

Various embodiments of the packet processing offload support capabilities, in which a general-purpose sNIC is used to support packet processing offload (including programmable switching offload), may overcome various problems or potential problems that are typically associated with use of hardware acceleration sNICs to support programmable switching offload. It is noted that, while the use of hardware acceleration sNICs to support programmable switching offload may keep the control plane unmodified by having the SDN controller manage the offloaded switch, instead of the host switch, it introduces several drawbacks in the data plane as discussed further below.

First, use of hardware acceleration sNICs to support programmable switching offload may result in inefficient intra-host communication. When the entire switching functionality is offloaded to the sNIC, VMs and NFs bypass the host hypervisor (e.g., via SR-IOV) and connect to the offloaded switch directly. While this architecture may be relatively efficient when the offloaded switch handles packet flows between local VMs/NFs and remote entities, inefficiency arises when traffic flows across VM/NF instances within the same host (which can be the case for service-chained NFs or the increasingly popular container-based micro-services architecture) since such intra-host flows must cross the host PCI bus multiple times back and forth between the hypervisor and the sNIC to avail the offloaded switch at the sNIC. This will restrict the local VM-to-VM and VM-to-NF throughput as memory bandwidth is higher than PCI bandwidth. Various embodiments of the packet processing offload support capabilities may reduce or eliminate such inefficiencies in intra-host communication.

Second, use of hardware acceleration sNICs to support programmable switching offload may result in limited switch port density. While SR-IOV communication between VMs/NFs and the offloaded switch can avoid the host hypervisor overhead, this places a limit on the number of switch ports. The maximum number of virtual functions can be limited due to hardware limitations of the sNIC (e.g., 32 for TILE-Gx) or operating system support. This may be particularly problematic when considering the high number of lightweight containers deployed on a single host and high port density supported by modern software switches. Various embodiments of the packet processing offload support capabilities may reduce or eliminate such switch port density limitations.

Third, use of hardware acceleration sNICs to support programmable switching offload may result in limited offload flexibility. In general, hardware acceleration sNICs typically are necessarily tied to specific packet processing implementations and, thus, do not provide much flexibility (in terms of offload decision and feature upgrade) or any programmability beyond the purpose for which they are designed. For example, it is not trivial to combine multiple offload capabilities (e.g., crypto and tunneling) in a programmatic fashion. Also, there is a lack of systematic support for multiple sNICs that can be utilized for dynamic and flexible offload placement. Various embodiments of the packet processing offload support capabilities may reduce or eliminate such offload flexibility limitations.

Fourth, use of hardware acceleration sNICs to support programmable switching offload may be limited by lack of operating system support. When switching functionality is accelerated via the sNIC, a set of offloadable hooks may be introduced to the host hypervisor (e.g., for forwarding, ACL, flow lookup, or the like). However, introduction of such hooks, to support non-trivial hardware offload in the kernel, has traditionally been opposed for a number of reasons, such as security updates, lack of visibility into the hardware, hardware-specific limits, and so forth. The same may be true for switching offload, thereby making its adoption in the community challenging. Various embodiments of the packet processing offload support capabilities may reduce or obviate the need for such operating system support.

Various embodiments of the packet processing offload support capabilities, in which a general-purpose sNIC is used to support packet processing offload (including programmable switching offload), may overcome the foregoing problems and may provide various other benefits or potential benefits.

Various embodiments of the packet processing offload support capabilities may provide various advantages or potential advantages. It is noted that embodiments of the packet processing offload support capabilities may ensure a single-switch northbound management interface for each end host, whether or not the end host is equipped with an sNIC, regardless of the number of sNICs that are connected to the end host, or the like. It is noted that embodiments of the packet processing offload support capabilities may achieve transparent packet processing offload using user-space management and control translation without any special operating system support (e.g., without a need for use of inflexible kernel-level hooks which are required in hardware accelerator NICs).

FIG. 8 depicts a high-level block diagram of a computer suitable for use in performing various operations presented herein.

The computer 800 includes a processor 802 (e.g., a central processing unit (CPU), a processor having a set of processor cores, a processor core of a processor, or the like) and a memory 804 (e.g., a random access memory (RAM), a read only memory (ROM), or the like). The processor 802 and the memory 804 are communicatively connected.

The computer 800 also may include a cooperating element 805. The cooperating element 805 may be a hardware device. The cooperating element 805 may be a process that can be loaded into the memory 804 and executed by the processor 802 to implement operations as discussed herein (in which case, for example, the cooperating element 805 (including associated data structures) can be stored on a non-transitory computer-readable storage medium, such as a storage device or other storage element (e.g., a magnetic drive, an optical drive, or the like)).

The computer 800 also may include one or more input/output devices 806. The input/output devices 806 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 800 of FIG. 8 may represent a general architecture and functionality suitable for implementing functional elements described herein, portions of functional elements described herein, or the like, as well as various combinations thereof. For example, computer 800 may provide a general architecture and functionality that is suitable for implementing all or part of one or more of EH 110, hypervisor 120, sNIC 130, NFC 151, SDNC 155, or the like.

It will be appreciated that at least some of the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive, at a virtualization switch of an end host configured to support a virtual data plane on the end host, port mapping information comprising a set of port mappings including a mapping of a virtual port of the virtual data plane of the virtualization switch to a physical port of an element switch of an element of the end host, the element switch of the element of the end host comprising a hypervisor switch of a hypervisor of the end host or a processing offload switch of a processing offload device of the end host;
translate, at the virtualization switch based on the port mapping information, a virtual flow rule specified based on the virtual port into an actual flow rule specified based on the physical port; and
send the actual flow rule from the virtualization switch toward the element switch of the element of the end host.

2. The apparatus of claim 1, wherein the processor is configured to:
receive the port mapping information from a network function agent of the end host based on creation of the virtual port on the virtual data plane of the virtualization switch.

3. The apparatus of claim 1, wherein the processor is configured to:
receive the virtual flow rule from a controller of a network with which the end host is associated.

4. The apparatus of claim 1, wherein the processor is configured to:
maintain a rule mapping between the virtual flow rule and the actual flow rule.

5. The apparatus of claim 1, wherein the processor is configured to:
receive updated port mapping information comprising a mapping of the virtual port to a new physical port; and
initiate reconfiguration of the end host based on the updated port mapping information.

6. The apparatus of claim 5, wherein the new physical port comprises:
a second physical port of the element switch of the element of the end host; or
a physical port of a second element switch of a second element of the end host.

7. The apparatus of claim 5, wherein, to initiate reconfiguration of the end host based on the updated port mapping information, the processor is configured to:
identify the virtual flow rule as being associated with the virtual port of the updated port mapping information;
identify the actual flow rule as being associated with the virtual flow rule; and
initiate removal of the actual flow rule from the element switch of the element of the end host.

8. The apparatus of claim 5, wherein, to initiate reconfiguration of the end host based on the updated port mapping information, the processor is configured to:
retranslate the virtual flow rule, based on the updated port mapping information, into a new actual flow rule specified based on the new physical port.

9. The apparatus of claim 8, wherein the new physical port comprises a second physical port of the element switch of the element of the end host, wherein the processor is configured to:
send the new actual flow rule toward the element switch of the element of the end host.

10. The apparatus of claim 8, wherein the new physical port comprises a physical port of a second element switch of a second element of the end host, wherein the processor is configured to:
send the new actual flow rule toward the second element switch of the second element of the end host.

11. The apparatus of claim 1, wherein the physical port is associated with a tenant virtual resource or a network function associated with a tenant virtual resource.

12. A non-transitory computer-readable storage medium storing instructions which, when executed by a computer, cause the computer to perform a method, the method comprising:
receiving, at a virtualization switch of an end host configured to support a virtual data plane on the end host, port mapping information comprising a set of port mappings including a mapping of a virtual port of the virtual data plane of the virtualization switch to a physical port of an element switch of an element of the end host, the element switch of the element of the end host comprising a hypervisor switch of a hypervisor of the end host or a processing offload switch of a processing offload device of the end host;
translating, at the virtualization switch based on the port mapping information, a virtual flow rule specified based on the virtual port into an actual flow rule specified based on the physical port; and
sending the actual flow rule from the virtualization switch toward the element switch of the element of the end host.

13. An apparatus, comprising:
a processor and a memory communicatively connected to the processor, the processor configured to:
instantiate a virtual resource on an element of an end host, the element of the end host comprising a hypervisor of the end host or a processing offload device of the end host;
connect the virtual resource to a physical port of an element switch of the element of the end host;
create a virtual port for the virtual resource on a virtual data plane of the end host; and
create a port mapping between the virtual port for the virtual resource and the physical port of the element switch of the element of the end host.

14. The apparatus of claim 13, wherein the processor is configured to:
select the element on which to instantiate the virtual resource based on at least one of resource utilization information from a resource monitor of the end host, bus bandwidth utilization information of the end host, or available hardware acceleration capabilities of the processing offload device.

15. The apparatus of claim 14, wherein the resource utilization information comprises at least one of a resource utilization of the hypervisor of the end host or a resource utilization of the processing offload device of the end host.

16. The apparatus of claim 13, wherein the processor is configured to:
send, toward a management system, an indication of the virtual port created for the virtual resource on the virtual data plane of the end host without providing an indication of the physical port of the element switch of the element of the end host that is associated with the virtual resource.

17. The apparatus of claim 13, wherein the processor is configured to:
send, toward a virtualization switch of the end host, the port mapping between the virtual port for the virtual resource and the physical port of the element switch of the element of the end host.

18. The apparatus of claim 13, wherein the processor is configured to:
initiate a migration of the virtual resource and associated virtual resource state of the virtual resource from the element of the end host to a second element of the end host; and
update the port mapping, based on the migration of the virtual resource from the element of the end host to the second element of the end host, to form an updated port mapping.

19. The apparatus of claim 18, wherein the processor is configured to initiate the migration of the virtual resource and associated virtual resource state of the virtual resource based on at least one of a resource utilization of the element of the end host or a resource utilization of the second element of the end host.

20. The apparatus of claim 18, wherein, to update the port mapping, the processor is configure to:
change the port mapping from being a mapping between the virtual port and the physical port of the element switch of the element of the end host to being a mapping between the virtual port and a physical port of a second element switch of the second element of the end host.

21. The apparatus of claim 18, wherein the processor is configured to:
send the updated port mapping toward a virtualization switch of the end host.

22. The apparatus of claim 18, wherein the element comprises a hypervisor of the end host and the second element comprises a processing offload device of the end host.

23. The apparatus of claim 18, wherein the element comprises a processing offload device of the end host, wherein the second element comprises a hypervisor of the end host.

24. A non-transitory computer-readable storage medium storing instructions which, when executed by a computer, cause the computer to perform a method, the method comprising:
instantiating, by a processor, a virtual resource on an element of an end host, the element of the end host comprising a hypervisor of the end host or a processing offload device of the end host;
connecting, by the processor, the virtual resource to a physical port of an element switch of the element of the end host;
creating, by the processor, a virtual port for the virtual resource on a virtual data plane of the end host; and
creating, by the processor, a port mapping between the virtual port for the virtual resource and the physical port of the element switch of the element of the end host.

25. An apparatus, comprising:
a processor and a memory communicatively connected to the processor, the processor configured to:
receive, by an agent of an end host from a controller, a request for instantiation of a virtual resource on the end host;
instantiate, by the agent, the virtual resource on an element of an end host, the element of the end host comprising a hypervisor of the end host or a processing offload device of the end host;
connect, by the agent, the virtual resource to a physical port of an element switch of the element of the end host;
create, by the agent on a virtual data plane of a virtualization switch of the end host, a virtual port that is associated with the physical port of the element switch of the element of the end host;
send, from the agent toward the controller, an indication of the virtual port without providing an indication of the physical port;
create, by the agent, a port mapping between the virtual port for the virtual resource and the physical port of the element switch of the element of the end host;
provide, from the agent to the virtualization switch, the port mapping between the virtual port for the virtual resource and the physical port of the element switch of the element of the end host; receive, by the virtualization switch from the controller, a virtual flow rule specified based on the virtual port;
translate, by the virtualization switch based on port mapping, the virtual flow rule into an actual flow rule specified based on the physical port; and
send, by the virtualization switch toward the element switch of the element of the end host, the actual flow rule.
